(19) United States
(12) Patent Application Publication
(10) Pub. No.: US 2009/0189757 A1
(43) Pub. Date: Jul. 30, 2009

(54) Room Management System

(76) Inventor: David A. Crum, Scottsdale, AZ (US)

Correspondence Address: THE LUTHER LAW FIRM, PLC, 10575 N 114TH STREET, SUITE 103, SCOTTSDALE, AZ, 85259, US

(21) Appl. No.: 12/340,528

(22) Filed: Dec. 19, 2008

Related U.S. Application Data
(60) Provisional application No. 61/008,770, filed on Dec. 21, 2007.

(51) Int. Cl. G08B 19/00; G08B 5/22; G08B 25/00

(52) U.S. Cl. 340/521; 340/825.36; 340/525

(57) ABSTRACT

Apparatus and method for managing utilization of rooms in a clinic, for example, include a visible display, including, for example, colored lights, at an examining room, indicating one or more of several available room status values for the room. An input device including, e.g., push buttons, is coupled to the display and adapted for selecting the room status value. A timer coupled to the input device and display automatically changes the status value of a room when a predetermined time period has elapsed after the status value is first selected, except when a third room status value is selected. This feature notifies personnel if, for example, a patient has been left alone in a room too long.

### BACKGROUND OF THE INVENTION

Efficient utilization of clinical examination rooms is becoming an increasingly growing challenge for clinics and hospitals. As the demand for outpatient examination rooms, physicians, nurses another staff that are directly involved in using or managing the examination room. This major trend that forced clinics and hospitals to consider making major staff or facility expansions and/or capital expenditure decisions. These decisions, however, often are made without solid information on how their examination rooms are being used, how long patients are waiting for a room to become available, how long it has been since housekeeping was notified that a room needs cleaning or maintenance, and so forth.

Without solid information concerning the manner in which examination rooms are being used, the administration of a clinic or hospital lacks detailed information concerning facility utilization. As a result, decisions as to whether or not another facility needs to be built, whether or not more staff needs to be hired and in what areas, and whether or not rooms can be reallocated or reconfigured at some facilities from one use to another. For example, can a room be re-allocated from oncology to cardiology? From cardiology to podiatry? From office space to exam rooms?

Many institutional audiences, such a patient, physicians, nurses, receptionists housekeeping and maintenance interact with an examination room. The coordination of all the activities, as it pertains to an examination room (that is, patient transport, patient examination, clean up, and equipment repairs), is not typically a data-driven series of events. Without hard data, however, medical staff, housekeeping and maintenance staff and administrators are hampered in their ability to make intelligent decisions on how the assets and resources are most effectively utilized.

For patients, present facility uses often mean that patients are not transported as quickly as otherwise might be possible to available examinations rooms. Frequently, searching for an empty room by simply walking down a corridor is the method by which a room is selected. Patients often experience long wait times for physicians and nurses through improper or inefficient room utilization.

It is desirable to provide a system which enables hospitals and clinics to maximize efficient utilization of examination rooms, saving time and money, improving the overall use of human and financial resources, and improving the patient experience.

### SUMMARY OF THE INVENTION

All of the examination rooms in a hospital or clinic facility are linked to a central control and monitoring station, where the individual status of each of the rooms is displayed at any given time. At each of the rooms, a status indicator is provided; and countdown timers are employed to provide indication at the central control station and, in some cases, on a display outside the door of a room itself, as to the various states of occupancy of the room at all times.

For example, an empty room has one indication at the room itself and at the control station. When a patient is placed in the room, this status is shown and a countdown timer commences for counting down the maximum time a patient should be left in the room. When a caregiver enters the room, a status is shown outside the room and at the central control station; and the designated caregiver is indicated on the outside of the room by color bars coded to the particular caregiver. When the room is empty if it needs cleaning, this is signaled and another countdown timer is initiated to establish the maximum length of time that the room awaits cleaning. Additional status indicator for cleaning, maintenance and the like also are provided; so that the actual status of the room may be observed on the outside of the room, as well as that a central station.

In accordance with the present invention, exemplary apparatus for observing utilization of one or more rooms includes at least one visibly indicating display adapted for location proximate a room and adapted for indicating at least one room status value selectable from a plurality of room status values; a manually operable input device operatively coupled to the display and adapted for selecting the at least one room status value selected from the plurality of room status values; and a timer operatively coupled to the input device, operatively coupled to the display, and adapted, with reference to the plurality of room status values, to select a predetermined second room status value when a predetermined time period has elapsed after a first room status value has been selected, except when a third room status value is selected from the plurality of room status values during the predetermined time period. This apparatus, as described here and as more fully developed below, not only can notify notifies office personnel as the rooms in the facility become, for example, vacant, reserved, occupied by a patient alone, occupied by a caregiver seeing a patient, in need of cleaning, in need of urgent attention, or out of service, but can also notify them of important changes in the status of a room, such as, for example, when a patient is left alone in a room for more than fifteen minutes, needs cleaning for more than fifteen minutes, or the like.

Exemplary apparatus in accordance with the present invention are adapted to provide a machine-retrievable data record of room status values for a room with respect to time. This record is later reported and analyzed to assist management, modification and planning of the facility.

Exemplary apparatus in accordance with the present invention has a visibly indicating and manually operable central monitoring station, operatively coupled to the display, the input device and the timer, adapted for indicating at least one room status value selectable from a plurality of room status values, and adapted for selecting the at least one room status value. This central station allows a manager to observe and alter the reported status of any of a plurality of rooms.

In exemplary apparatus in accordance with the present invention, the predetermined plurality of status values includes at least one provider identifier. Thus, the provider presses one or more buttons upon entering or leaving a room, with the effect that one or more rooms status values is displayed indicating not only what is happening in the room but which caregiver, or provider, is present or is giving the indication.

In exemplary apparatus in accordance with the present invention, the predetermined plurality of status values includes at least one status value selected from the set including “reserved room,” “patient in room,” “caregiver in room,” “timer exceeded,” “cleaning required,” “pull cord,” and “room out of service.” Other values are added to the set as needed by management.

Exemplary apparatus in accordance with the present invention the display has a plurality of lights, respective ones of the lights corresponding to respective ones of the room status values.

In exemplary apparatus in accordance with the present invention, the input device has a plurality of momentary contact switches, respective ones of the switches corresponding to respective ones of the room status values.

In exemplary apparatus in accordance with the present invention, the timer is adapted to select the second status value “timer exceeded” when a predetermined time period has elapsed after a first room status value of “patient in room” or “cleaning required” has been selected. This operation is useful in avoiding patient discomfort and frustration.

Exemplary apparatus in accordance with the present invention has a manually operable pull-cord alarm located proximate a room, operatively coupled to the display, and adapted to select the room status value “pull cord” when manually operated.

In exemplary apparatus in accordance with the present invention, the monitoring station is adapted to display a plurality of room status values of a plurality of rooms, respective ones of the plurality of displayed room status variables being discernibly associated with respective ones of the plurality of rooms. This provides flexible, comprehensive awareness of the status of rooms in the facility.

An exemplary method of managing utilization of one or more rooms in accordance with the present invention has the steps of selecting proximate a room at least one first room status value selectable from a plurality of room status values; displaying proximate the first room the selected room status value; and automatically selecting a second room status value selectable from the plurality of room status values when a predetermined time period has elapsed after a first room status value has been selected, except when a third room status value is selected from the plurality of room status values during the predetermined time period.

An exemplary method in accordance with the present invention has the step of providing a machine-retrievable data record of a room status values for a room with respect to time.

An exemplary method in accordance with the present invention has at least one further step selected from the set of steps including (a) at a central station selecting a room status value, and (b) at the central station and proximate the room indicating the selected room status value.

In an exemplary method in accordance with the present invention, a room status value includes at least one provider identifier.

In an exemplary method in accordance with the present invention, the predetermined plurality of status values including at least one status value selected from the set including “reserved room,” “patient in room,” “caregiver in room,” “timer exceeded,” “cleaning required,” “pull cord,” and “room out of service.”

An exemplary method in accordance with the present invention has the step of illuminating at least one of a plurality of lights, respective ones of the lights corresponding to respective ones of the room status values.

An exemplary method in accordance with the present invention has the further step of operating one or more of a plurality of momentary contact switches, respective ones of the switches corresponding to respective ones of the room status values.

In an exemplary method in accordance with the present invention, the step of automatically selecting includes selecting the second status value “timer exceeded” when a predetermined time period has elapsed after a first room status value of “patient in room” or “cleaning required” has been selected.

An exemplary method in accordance with the present invention includes the step of manually operating a pull-cord alarm located proximate a room and operatively coupled to the display, and selecting the room status value “pull cord” when the pull-cord alarm is operated.

An exemplary method in accordance with the present invention includes the step of displaying at the monitoring station a plurality of room status values of a plurality of rooms, respective ones of the plurality of displayed room status variables being discernibly associated with respective ones of the plurality of rooms.

### BRIEF DESCRIPTION OF THE DRAWINGS

FIG. 1 is a block diagram of a system of n embodiment of the invention;

FIG. 2 is a flow chart useful in explaining the operation of the embodiment of FIG. 1;

FIG. 3 is a diagrammatic depiction of a display at a monitoring station of the embodiment of FIG. 1;

FIG. 4 is a representation at a monitoring station of the status of a block of rooms of the embodiment of FIG. 1;

FIGS. 5, 6 and 7 are representations of the status of light bars at each of the rooms depicted in FIG. 4; and

FIGS. 8 through 14 are representations of the control panel and display at a room indicative of its use.

### DETAILED DESCRIPTION

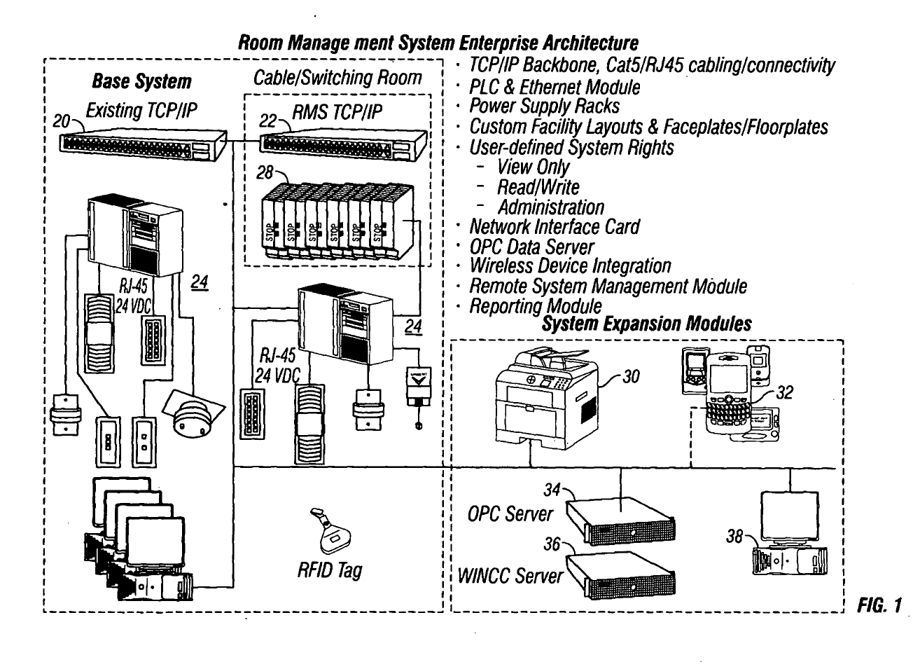

Reference now should be made to the drawings, wherein the same reference numbers are used throughout the different figures to designate the same or similar components. The system shown in FIG. 1 uses web-enabled software to permit users of the system to monitor and control the status of any room which is equipped with the room management system components of an embodiment of the invention. The status can be monitored and controlled from any web-enabled nursing station, mobile phone (monitor only) or other web-enabled device (monitor only).

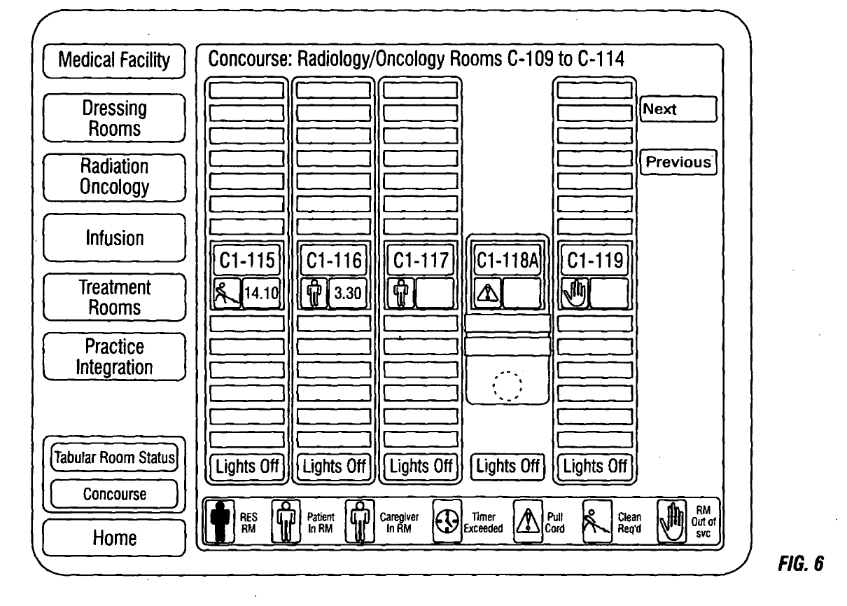

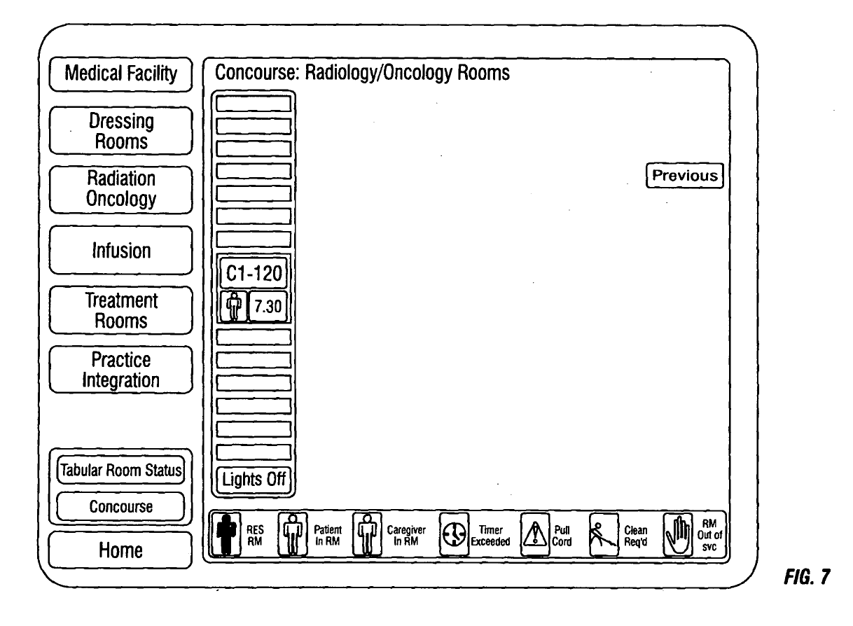

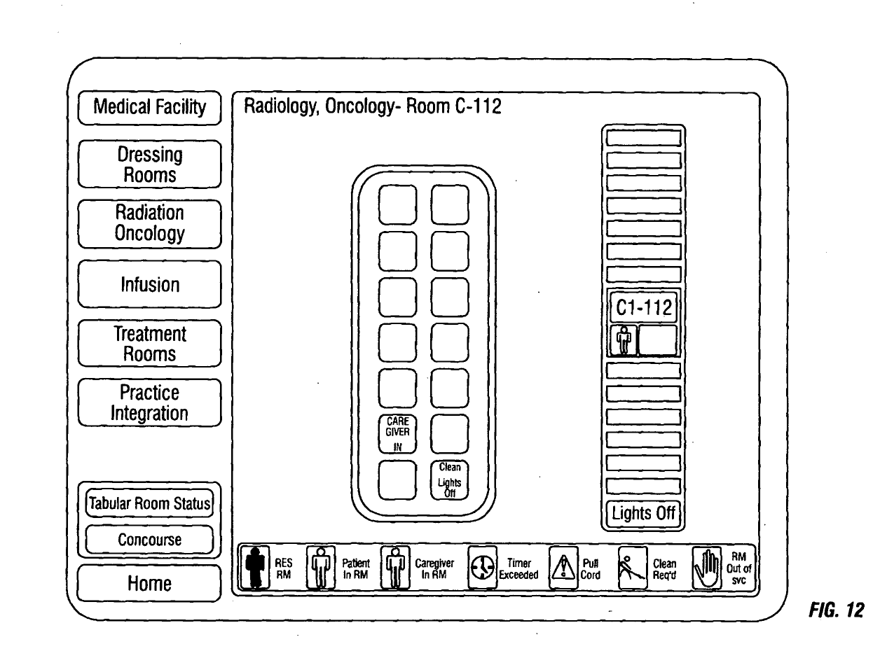

In general the system uses a plug-n-play (via RJ45 connectors), high intensity light tower sconces at each room which integrate directly with a controller and associated software. Room occupancy status, in the embodiment disclosed in FIGS. 1 through 14, is signaled by simply pressing well-labeled buttons on a keypad outside the door of each room. The keypad also is integrated into the system. Inputs are received either directly from the keypad, or remotely from a connected PC (Personal Computer) at a monitor station 26. The resulting outputs are lights which are turned on physically at the light tower, and are also connected logically in the system software to be viewed on any connected PC at a monitor station 26. These inputs and outputs are controlled through a programmable logic controller (PLC) 28 and are communicated via an Ethernet module and Ethernet connection, and are stored for history and reporting purposes on an OPC server.

The room management system of the disclosed embodiment is a tool for communication patient flow, managing work flow and improving clinical processes. A specific workflow example is described subsequently, from the time a patient checks in through the end of a patient visit, to subsequent readiness for the next patient visit. Through this process, the various status of the room are tracked throughout each day; and the data is retained for tie-based room utilization reporting. Room occupancy data based on the status of the lights on a per-room basis are seamlessly collected and synthesized within the system's PLC and OPC server. A variety of standard reports are available to be generated on command from the stored data.

Room usage reports enable administrators to manage and adjust resources, as needed. In addition, the reports allow for robust resourced planning, adding an important level of data to decisions involving the reconfiguration of existing facilities, facility expansion and/or construction of new buildings.

FIG. 1 is a diagrammatic representation of a room management system enterprise architecture of an embodiment of the invention. The base system includes and existing TCP/IP untie 20, which is connected to a cable switching room (RMS TCP/IP) 22 and to a plurality of room control units 24 (two of which are shown in FIG. 1), as well as to a computer monitoring/control station(s) 26. In the cable switching room, connections are made to the various rooms 24 through a controller 28. This portion of FIG. 1 constitutes the base system.

In addition to the base system, however, expansion modules in the form of a printer 30 and cell phones or PDA devices 32, along with OPC servers or WINCC servers 34 and 36 may be provided. Also, a remote monitor 38 interconnected as described above may be provided. The base system, however, comprises the elements 10, 22, 24, 26 and 28.

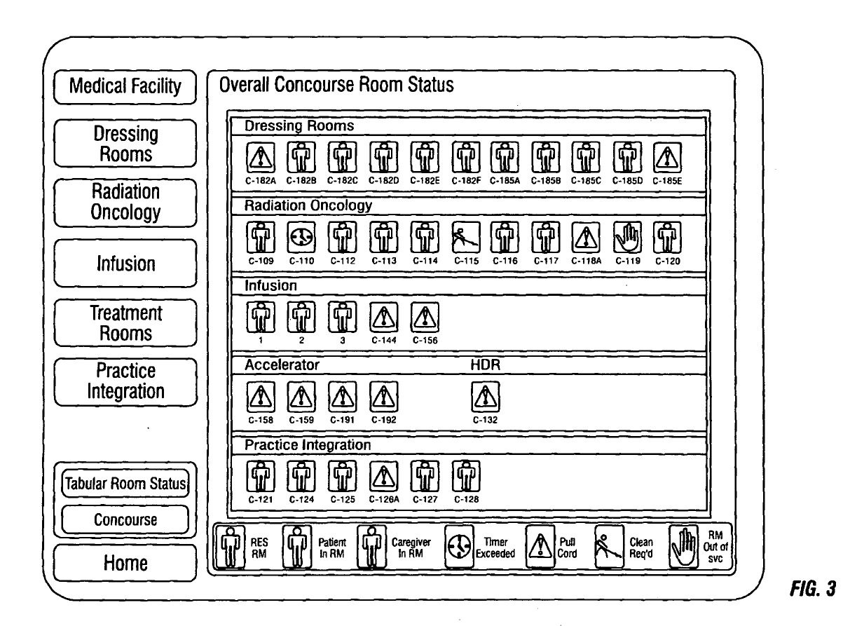

FIG. 3 is a representation of a display of the type which may be provided at the monitor 26 of FIG. 1. The display in FIG. 3 is used for a facility having a variety of different types of rooms identified in FIG. 3 as dressing rooms, radiation, oncology, infusion, accelerator, and practice integration. As the bottom of FIG. 3 are icons which represent the status which is provided by the system to enable a person at the monitoring station 26 to understand, at any given time, what the status is of the various rooms which are shown. For the purpose of this description, the room set identified as “Radiation Oncology” will be considered.

As shown in FIG. 3, the status (referring to the icons at the bottom of FIG. 3) of Rooms C109 and C116 is that there is a patient in the room. Room C110 has a timer exceeded, and requires some type of attention. Rooms C112 and C114 are empty. Room C113 has been reserved for a patient. Room C115 requires cleaning; and this is shown by the status indicator. Rooms C117 and C120 have a caregiver in those rooms. Room C118A has a pull-cord alarm; and Room C119 is out of service. The status of all of these rooms can be instantly ascertained by and operator at the monitor station 26 viewing the radiation oncology line.

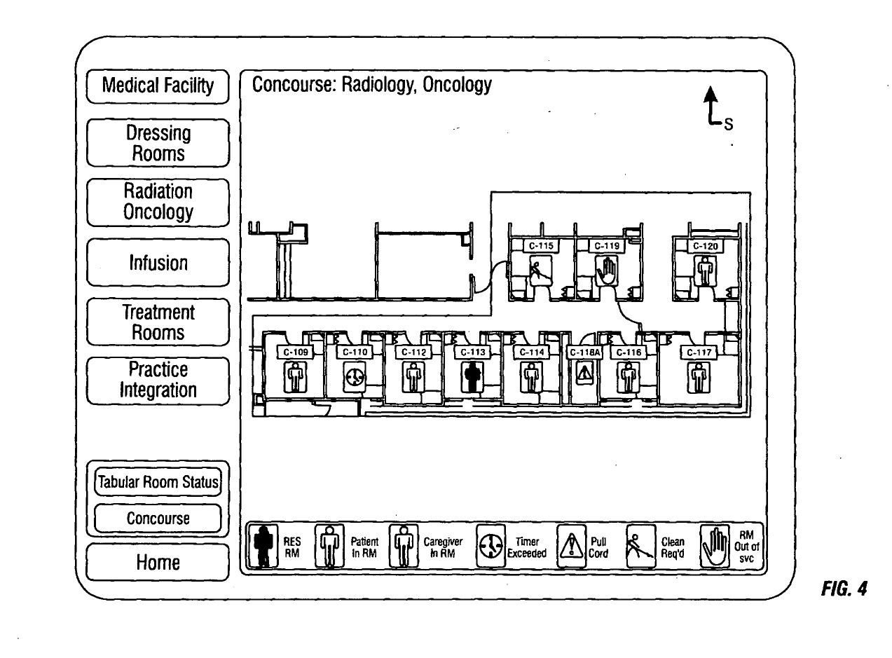

FIG. 4 is similar to FIG. 3 in the data that it depicts, except that it is limited specifically to the radiation oncology rooms. The room status which has been described above in conjunction with FIG. 3 is also displayed in FIG. 4; and whenever an operator at the monitor 26 desires to view the status only of this set of rooms, the screen which is shown in FIG. 4 is pulled up by operating the “radiation oncology” button on the left side of the screen of the display.

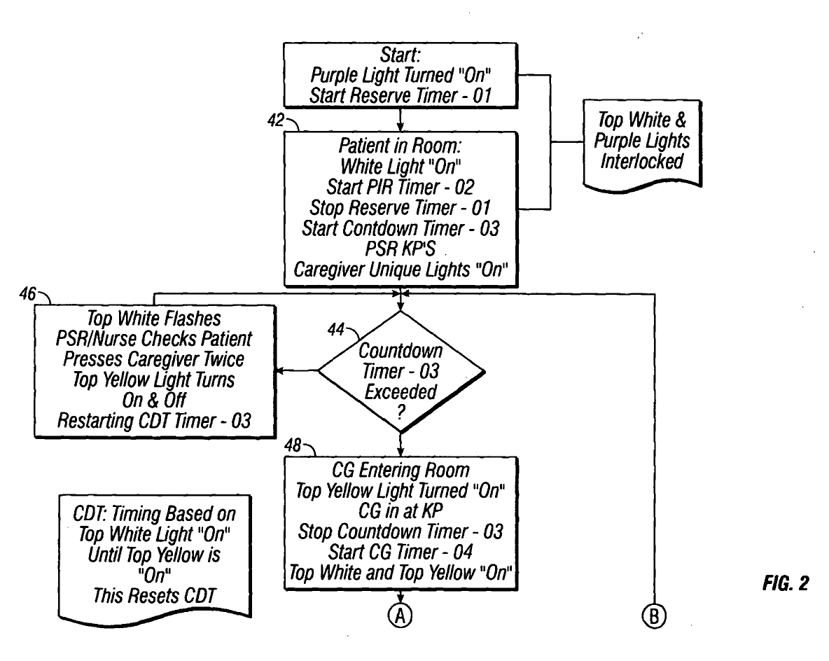

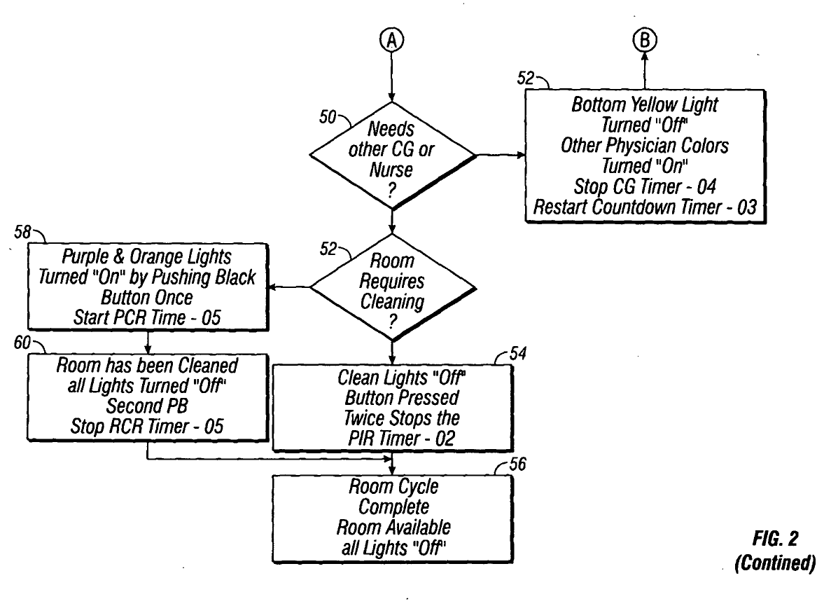

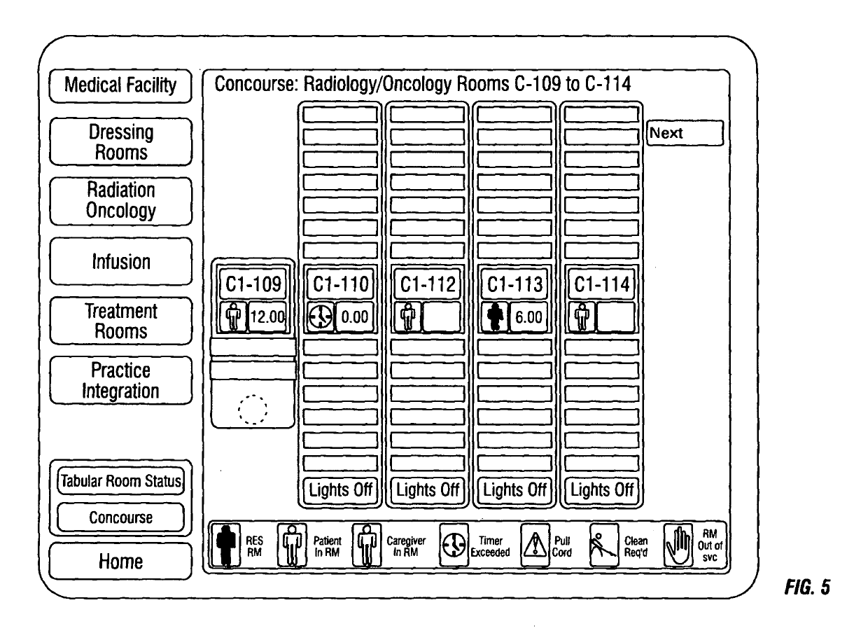

FIGS. 5, 6 and 7 are an alternative display for rooms C109 through C120, also which may be depicted on the monitors 26, but which are also showing the light tower indicia which is present on the light tower sconce located outside the door of each of the different rooms. The depictions which are shown for these different rooms are described below in conjunction with the flow chart of FIG. 2.

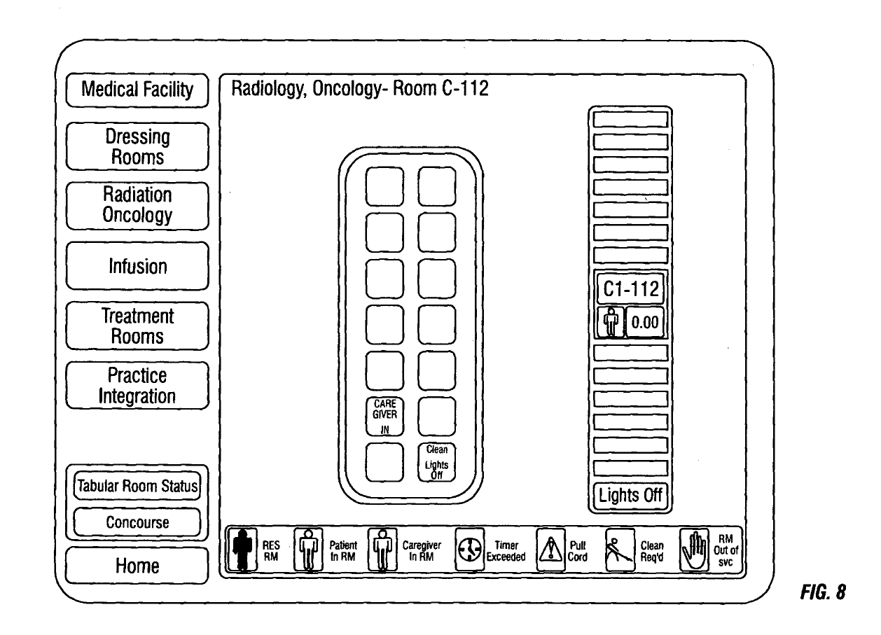

Whenever a room is to be reserved for a patient, such as room C113 in FIGS. 3, 4 and 5, the purple light is turned on, either from the control monitor 26 or from a control panel located adjacent the light tower sconce outside the room. Such a control panel is shown in the left side of the screen depiction in FIG. 8. This reservation of a room is shown at 40 in FIG. 2. At the time the reserve light is turned on at the room and at the display at the monitor 26, a start reserve time is initiated. This timer continues to provide a countdown of the time the room is in the reserve status for subsequent data reporting of the utilization of the room. When a patient is placed in the room at 42, the white light button shown at the top of the button panel in FIG. 8 is depressed, wither outside the room or at the monitor station 26. For purposes of discussion of FIG. 2, reference should be made specifically to the display FIGS. 8 to 14, which are shown in the present example for the status of room C112. FIG. 8 shows the room when it is in its empty status with all of the lights on the light tower sconce (shown on the right-hand side of FIG. 8 through 14) turned off. Consequently, it is apparent to anyone walking down the hall or at the monitor station 26 that this room is empty and available for use.

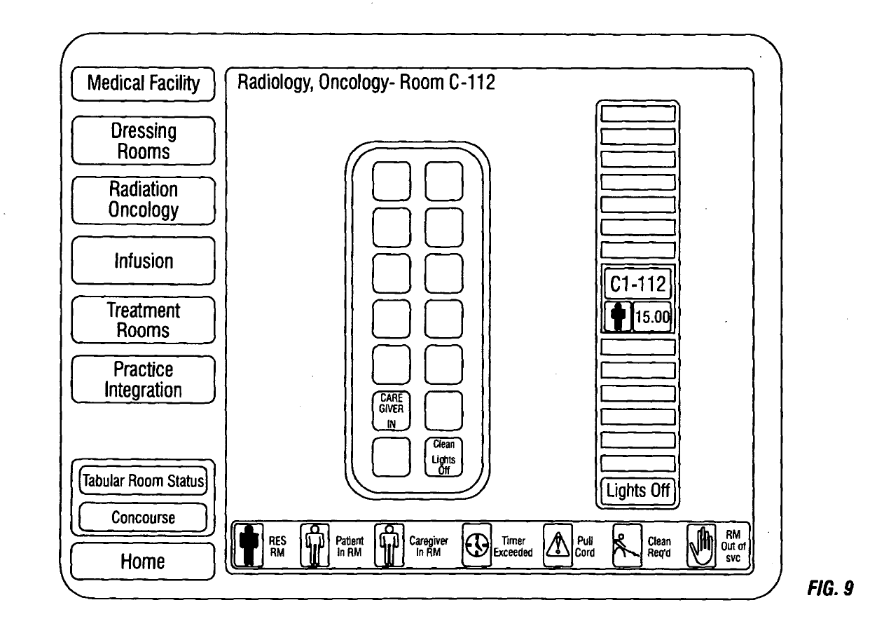

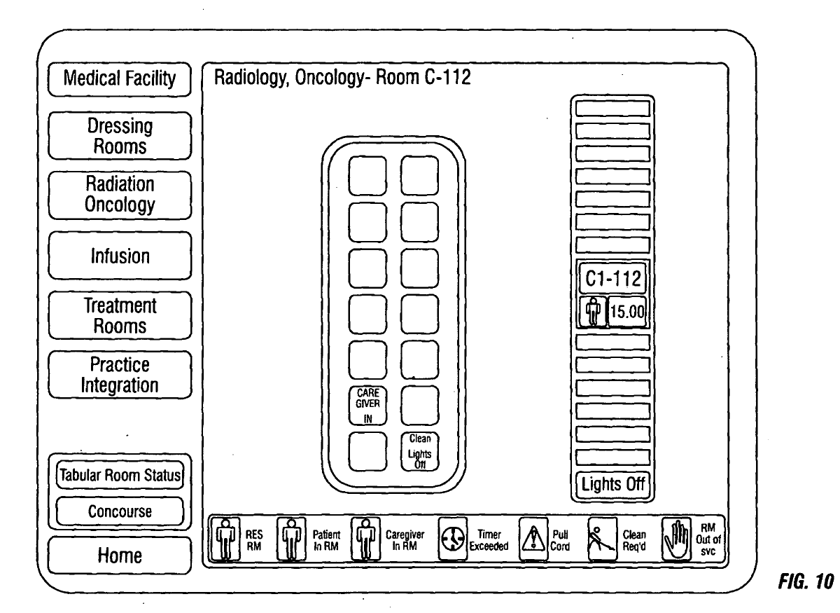

As shown in FIG. 9, whenever a room is reserved, the purpose light shown at the top of the light tower sconce in FIG. 9 is turned on; and the timer shows the elapsed time that the room has been in this reserve status. When the patient is placed in the room at 42 in FIG. 2, the white light button (FIG. 10) is turned on and a white light is shown at two places, near the top of the light tower sconce and immediately below the icon showing the patient in room. A colored button (red in FIG. 10) for the caregiver assigned to the patient also is depressed and alight bar of that color is displayed on the light tower.

A countdown timer PRI is started. Typically, a timer is set for fifteen minutes or less, depending upon the manner of use of the facility. This timer continues to count down the time at 44 in FIG. 2. If the timer exceeds the countdown, the timer exceeded symbol appears on the room; and the top white light on the light tower flashed to indicate that the patient has been left in the room for more that the maximum time desired by the facility. When this occurs, the buttons for the caregiver indicated by the bar on the light tower (red in the present example) are pressed twice, and the top yellow light immediately above the room number flashes on and off. At the same time, the countdown timer is restarted, bringing the system back to 44, as shown in FIG. 2.

It should be noted that whenever a patient is placed in a room, the colored push button for the particular caregivers who is to attend to that patient is pressed to cause the light for that caregiver to be turned for the room. This is the red light shown in FIG. 10.

Whenever the countdown timer has not reached its maximum, causing the event noted above to occur, a caregiver entering the room at 48 in FIG. 2 pushed the “caregiver in” button to stop the countdown timer. This then causes the yellow light to be turned on immediately above the room number display; and the two whit lights remain on, and the icon in the icon window is turned from white to yellow. It should be noted that the countdown timer for establishing how many minutes the patient is in the room before a caregiver enters the room is based on the top white light being on until the top yellow light is turned on. When these two events coincide, the countdown timer is reset to zero and is held there.

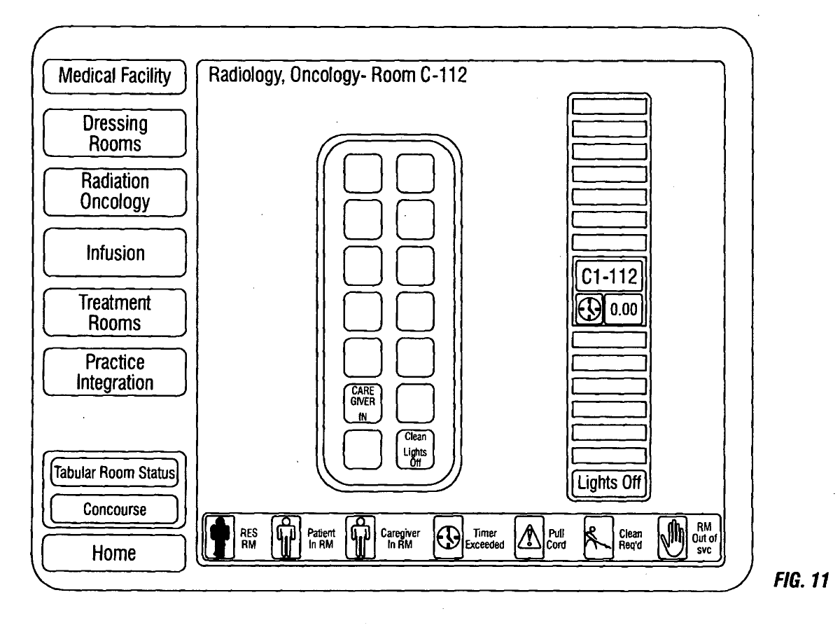

If another caregiver or a nurse is needed at 50, a push button on the display panel is depressed; and the bottom yellow light is turned off at 52. The other physician color, such as the red one shown in FIG. 11, is either turned on or continues to be turned on. The caregiver timer is stopped; and the countdown timer once again is started, as shown by the arrow returning from block 52 to the top of block 44 in FIG. 2.

Once the caregiver indicated by the colored bar (red in FIG. 11) enters the room and presses the corresponding button on the control panel, the countdown timer is turned off; but the timer is turned on and runs to show the duration of the time the provider (represented by the red indicia) is in the room.

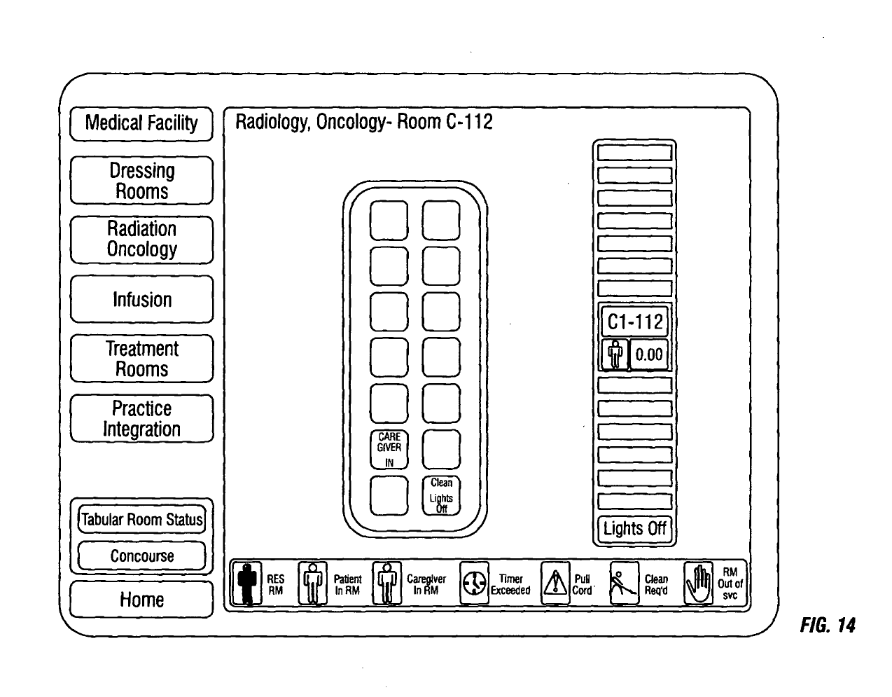

When everything is finished, the selection from 50 is that no other caregiver or nurse is required; and the patient and caregiver leave the room. A decision is made at 52 as to whether or not the room requires cleaning. If it does not, the “clean-lights off’ button on the panel is depressed at 54. Depressing this button a second time stops the patient in room timer, and shows that the room cycle is complete and that the room is available at 56. This condition is depicted on the status of the light tower sconce shown on the right-hand side of FIG. 14.

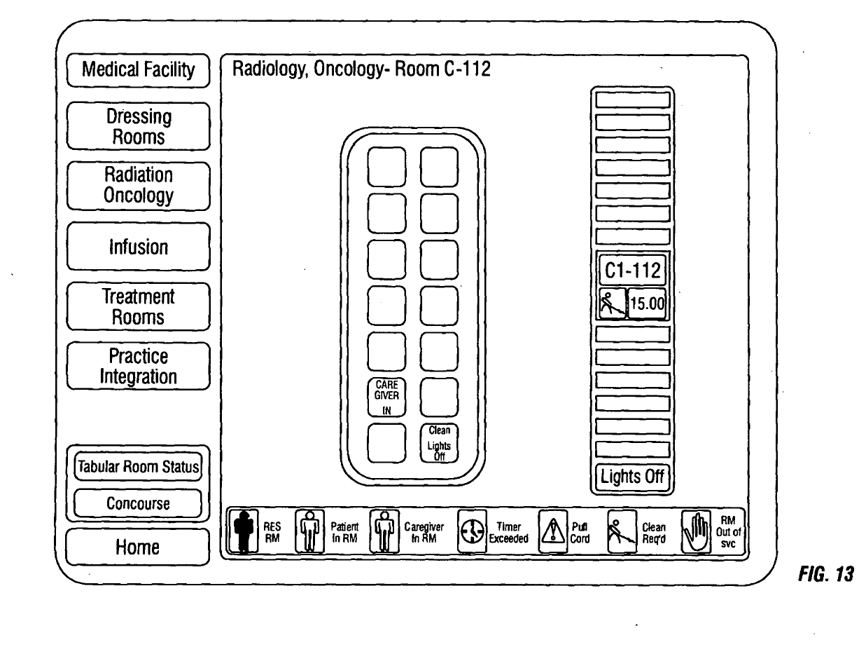

If the room does require cleaning at 52, the indication is made by pushing the “clean-lights off” button once at 58. This turns on the purple and orange light bars, as shown in FIG. 13 and starts a room cleaning timer (RCR), which, as shown in FIG. 13, is a fifteen minute timer. Also, note in FIG. 15, that the icon for cleaning the room also is displayed on the light tower sconce. After the room has been cleaned, the “clean-lights off” button is pressed a second time at 60, and the room cycle is complete, room available, all lights off indication at 56 is also achieved, as again shown in FIG. 14.

The foregoing system provides a highly flexible, visible monitoring system for managing and monitoring the status of an examination room (or other room) at any given time. The nature of personnel in the room and whether a caregiver is present with a patient or not is readily ascertained by the status of the light bars on the outside of the room. In addition, the particular caregiver represented by the different color bars below the room number also is ascertained at the room itself, as well as available at the monitoring station 26. By coupling the various timers and status indicators with a timer of day clock, the data concerning the usage and occupancy of the room throughout all of the different hours of a day may be monitored and stored n a data bank. This information then subsequently can be retrieved and used for management purposes to determine the extent of usage and the manner of utilization of the rooms. Based on this data, decisions can be made for determining a more effective work flow and usage of rooms and/or whether additional facilities need to be obtained. Even without this reporting information, the work flow of the particular examination rooms in any given facility is greatly enhanced by means of the ability to monitor the status of all of the rooms at any given time, both from a location outside the door of each examination room, as well as at a central monitoring station 26.

The foregoing description of an embodiment of the invention is to be considered as illustrative and not as limiting. Various changes and modifications will occur to those skilled in the art for performing substantially the same function, in substantially the same way, to achieve substantially the same result, without departing from the true scope of the invention.

1. An apparatus for observing utilization of one or more rooms, comprising:
at least one visibly indicating display adapted for location proximate a room and adapted for indicating at least one room status value selectable from a plurality of room status values;
a manually operable input device operatively coupled to said display and adapted for selecting said at least one room status value selected from said plurality of room status values; and
a timer operatively coupled to said input device, operatively coupled to said display, and adapted, with reference to said plurality of room status values, to select a predetermined second room status value when a predetermined time period has elapsed after a first room status value has been selected, except when a third room status value is selected from said plurality of room status values during said predetermined time period.

2. The apparatus of claim 1, further adapted to provide a machine-retrievable data record of room status values for a room with respect to time.

3. The apparatus of claim 1, further comprising a visibly indicating and manually operable central monitoring station, operatively coupled to said display, said input device and said timer, adapted for indicating at least one room status value selectable from a plurality of room status values, and adapted for selecting said at least one room status value.

4. The apparatus of claim 1, wherein said predetermined plurality of status values includes at least one provider identifier.

5. The apparatus of claim 1, wherein said predetermined plurality of status values includes at least one status value selected from the set including “reserved room,” “patient in room,” “caregiver in room,” “timer exceeded,” “cleaning required,” “pull cord,” and “room out of service.”

6. The apparatus of claim 1, wherein said display further comprises a plurality of lights, respective ones of said lights corresponding to respective ones of said room status values.

7. The apparatus of claim 1, wherein said input device further comprises a plurality of momentary contact switches, respective ones of said switches corresponding to respective ones of said room status values.

8. The apparatus of claim 1, wherein said timer is adapted to select the second status value “timer exceeded” when a predetermined time period has elapsed after a first room status value of “patient in room” or “cleaning required” has been selected.

9. The apparatus of claim 5, further comprising a manually operable pull-cord alarm located proximate a room, operatively coupled to said display, and adapted to select the room status value “pull cord” when manually operated.

10. The apparatus of claim 3, wherein said monitoring station is adapted to display a plurality of room status values of a plurality of rooms, respective ones of said plurality of displayed room status variables being discernibly associated with respective ones of said plurality of rooms.

11. A method of managing utilization of one or more rooms, having the steps of:
selecting proximate a room at least one first room status value selectable from a plurality of room status values;
displaying proximate said first room said selected room status value; and
automatically selecting a second room status value selectable from said plurality of room status values when a predetermined time period has elapsed after a first room status value has been selected, except when a third room status value is selected from said plurality of room status values during said predetermined time period.

12. The method of claim 11, further comprising the step of providing a machine-retrievable data record of a room status values for a room with respect to time.

13. The method of claim 11, further comprising at least one step selected from the set of steps including (a) at a central station selecting a room status value, and (b) at said central station and proximate said room indicating said selected room status value.

14. The method of claim 11, wherein a room status value includes at least one provider identifier.

15. The method of claim 11, wherein said predetermined plurality of status values includes at least one status value selected from the set including “reserved room,” “patient in room,” “caregiver in room,” “timer exceeded,” “cleaning required,” “pull cord,” and “room out of service.”

16. The method of claim 11, further comprising the step of illuminating at least one of a plurality of lights, respective ones of said lights corresponding to respective ones of said room status values.

17. The method of claim 11, further comprising the step of operating one or more of a plurality of momentary contact switches, respective ones of said switches corresponding to respective ones of said room status values.

18. The method of claim 11, said step of automatically selecting comprising selecting the second status value “timer exceeded” when a predetermined time period has elapsed after a first room status value of “patient in room” or “cleaning required” has been selected.

19. The method of claim 15, further comprising the step of manually operating a pull-cord alarm located proximate a room and operatively coupled to said display, and selecting the room status value “pull cord” when said pull-cord alarm is operated.

20. The method of claim 13, further comprising the step of displaying at said monitoring station a plurality of room status values of a plurality of rooms, respective ones of said plurality of displayed room status variables being discernibly associated with respective ones of said plurality of rooms.
